(19) United States
(12) Patent Application Publication
(10) Pub. No.: US 2026/0249675 A1
(43) Pub. Date: Aug. 27, 2026

(54) FRONT SUPPORT FOR A POWER DISTRIBUTION CENTER OF AN ELECTRIC VEHICLE

(71) Applicant: FCA US LLC, Auburn Hills, MI (US)

(72) Inventors: Michael L Nemeth, Auburn Hills, MI (US); Kevin A Spangler, Auburn Hills, MI (US); Christopher G Gomez, Auburn Hills, MI (US); Steven M Hudak, Auburn Hills, MI (US); Beth L Blake, Auburn Hills, MI (US); Hisham Imad Ali, Auburn Hills, MI (US)

(21) Appl. No.: 19/065,413

(22) Filed: Feb. 27, 2025

(51) Int. Cl. B60K 1/04; B60K 6/26; B60K 6/28; B60K 6/40; B60K 15/01; B60L 50/60; B62D 21/03; H01M 50/249

(52) U.S. Cl. CPC B60K 1/04; B60K 6/26; B60K 6/28; B60K 6/40; B62D 21/03; H01M 50/249; B60K 15/01; B60L 50/66; B60Y 2200/92; B60Y 2400/112; B60Y 2400/60; B60Y 2410/113; H01M 2220/20

(57) ABSTRACT

A vehicle includes a first frame rail, a second frame rail, and a frame cross member disposed between the first frame rail and the second frame rail. A first support bracket is coupled to the frame cross member and the second frame rail above a battery. A second support bracket is coupled to the first support bracket. A power distribution center is coupled to the second support bracket.

### FIELD

The present disclosure relates to a power distribution system for an electrified vehicle, and, more specifically, to a supporting structure for the power distribution center to prevent interference with various components.

### BACKGROUND

This section provides background information related to the present disclosure which is not necessarily prior art.

It is very common for vehicles to have packaging issues. With the number of electronic devices included in the vehicles, packaging components is often difficult. The electrification of vehicles has increased the number of vehicle components. Batteries require a significant amount of volume within the vehicle. Therefore, packaging in an electrified vehicle is even more challenging than a traditional vehicle.

Because of the number of components in an electrified vehicle, packaging is of concern. Positioning components that are packaged must take into consideration the assembly process of the vehicle and the servicing of the vehicle. In certain electric vehicles, the battery must be removed toward the bottom of the vehicle. However, during manufacture, the components must be able to be installed from the top of the vehicle.

### SUMMARY

This section provides a general summary of the disclosure and is not a comprehensive disclosure of its full scope or all of its features.

The present system provides a vehicle configuration that allows for the assembly process and the serving of the electric vehicle.

In one aspect of the disclosure, a vehicle includes a first frame rail, a second frame rail and a battery disposed between the first frame rail and the second frame rail. A first support bracket is coupled to the first frame rail and the second frame rail above the battery. A power distribution center is coupled to the first support bracket. A plurality of high voltage wires is coupled to the power distribution center. A second support bracket is coupled to the first support bracket. The second support bracket is coupled to the high voltage wires.

In another aspect of the disclosure, a vehicle includes a first frame rail, a second frame rail, and a frame cross member disposed between the first frame rail and the second frame rail. A first support bracket is coupled to the frame cross member and the second frame rail above a battery. A second support bracket is coupled to the first support bracket. A power distribution center is coupled to the second support bracket.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of the electrical system of an electrified vehicle.

FIG. 2A is a partial perspective view of the vehicle tunnel and battery.

FIG. 2B is a perspective view of the battery and the electrical control components with the tunnel cover removed.

FIG. 2C is a perspective view showing the battery separated from the vehicle 10.

FIG. 2D is a cross-sectional view through the battery and PDC of the vehicle.

FIG. 2E is an exploded view of the front bracket assembly and the rear bracket assembly relative to the PDC.

FIG. 3A is a perspective view of the front bracket assembly and the rear bracket assembly having the fuel lines and the high voltage wire in a simplified version without other components of the vehicle.

FIG. 3B is a perspective view similar to FIG. 3A with the high voltage wires and the fuel lines removed.

FIG. 3C is a top view of the assembly of FIG. 3B.

FIG. 3D is a front view of the assembly of FIG. 3B.

FIG. 4A is a side perspective view of the front bracket assembly and the rear bracket assembly relative to the battery 24 showing a gap therebetween.

FIG. 4B is a bottom view of the PDC with the front bracket assembly coupled thereto.

FIG. 4C is an exploded view of the assembly illustrating the method for assembling the brackets.

FIG. 5 is a perspective view of the front bracket assembly having an alternate design for the third front bracket.

Corresponding reference numerals indicate corresponding parts throughout the several views of the drawings.

### DETAILED DESCRIPTION

Example embodiments will now be described more fully with reference to the accompanying drawings.

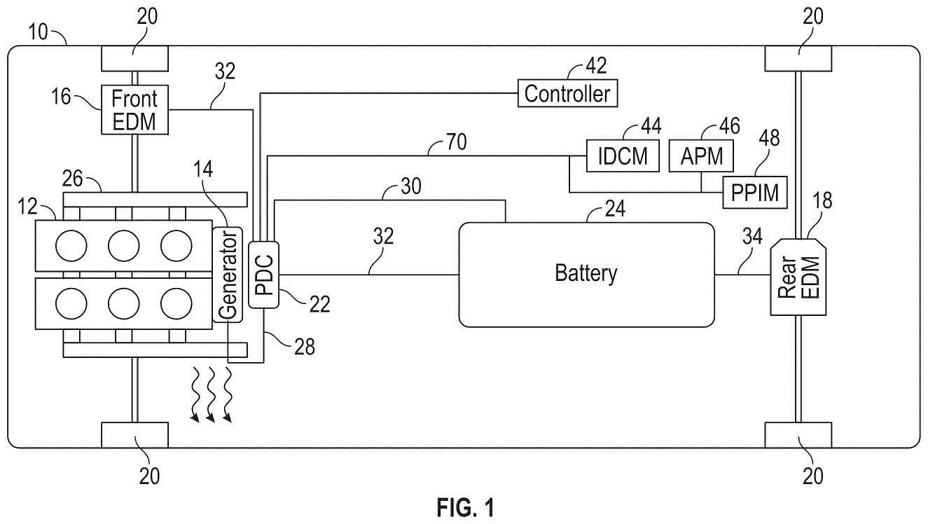

Referring now to FIG. 1, a high-level block diagram of a vehicle 10 is depicted. Examples of a type of vehicle include, but are not limited to battery electric vehicles (BEV), hybrid electric vehicle (HEV), plug-in hybrid electric vehicle (PHEV), range extending electric vehicles (REV) and fuel cell electric vehicles (FCEV).

In the depicted example, the vehicle 10 comprises an internal combustion engine 12, a generator 14, a front motor 16, which may be referred to as a front electric drive motor (EDM), and a rear motor 18, which may be referred to as a rear electric drive motor. The front motor 16 and rear motor 18 are connected to and provide motive power to the wheels 20. More than two EDMs such as two rear motors, two front motors or two front motors and two rear motors are other examples. In this example, the engine 12 is not mechanically connected to the wheels 20, but in other examples the engine 12 is mechanically connected to the wheels 20 through a transmission and provides motive force to the wheels 20. The engine 12 is connected to the generator 14 which produces electrical energy for the powertrain from the mechanical energy produced by the engine 12. In a fuel cell vehicle, the engine and generator are replaced by a fuel cell.

The generator 14 is electrically coupled to a power distribution center 22. The power distribution center (PDC) 22 is used for controlling the power and distributing the power to the various devices within the vehicle 10. The (PDC) 22 may include power electronics such as a power inverter module by a HV cable 28. In one example, the HV cable 28 is a single cable. In another example, the HV cable 28 comprises one or more cables as illustrated below. The generator 14 provides electrical energy to charge the battery 24 by an HV cable 30 and provides electrical energy to the battery 24 through the HV cable 30. More than 1 HV cable is likely to be used as described below. The front motor 16 is connected to the power distribution center 22 by an HV cable 32 (or cables) and receives electrical energy from the battery though the HV cable 32. The rear motor 18 is connected to the battery 24 by an HV cable 34 and receives electrical energy from the battery 24 though the HV cable 34.

A controller 42 may be coupled to the power distribution center 22. However, the controller 42 may be part of a vehicle controller or a portion thereof. The vehicle controller 42 may be one of several microprocessors coupled together to perform various functions within the vehicle 10.

The PDC 22 may be coupled to various components such as the integrated dual charging module (IDCM) 44, the auxiliary power module (APM), and the primary power inverter module 48 though the high voltage cable 70. Different modules may be used in different types of vehicles.

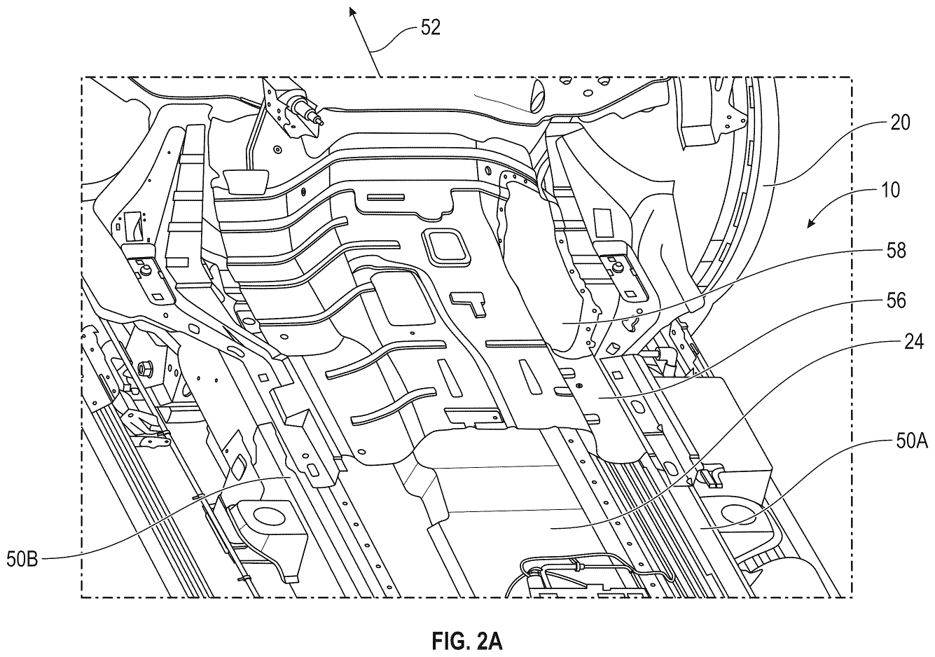

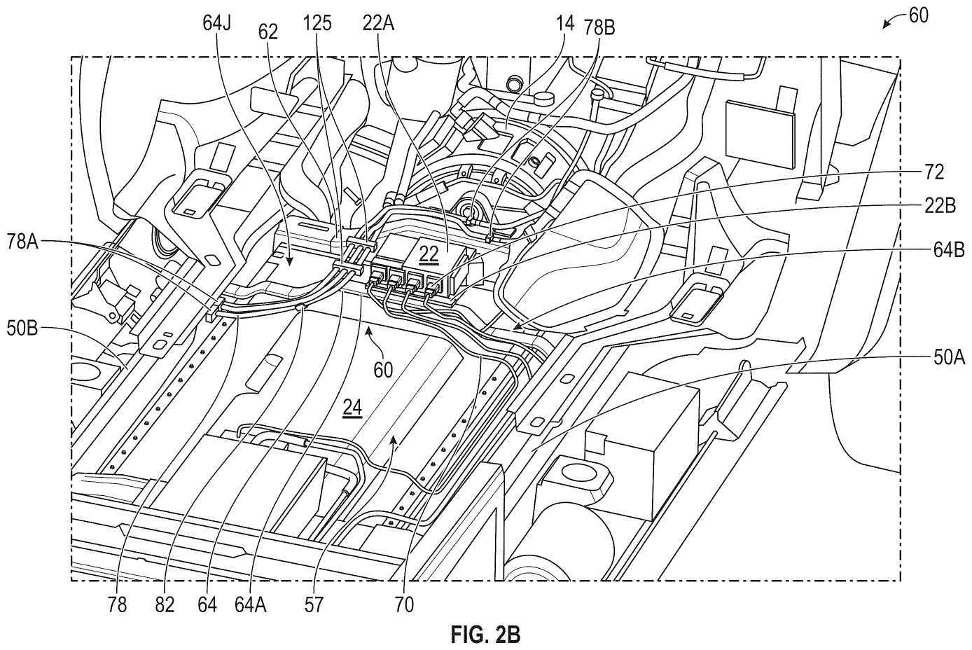

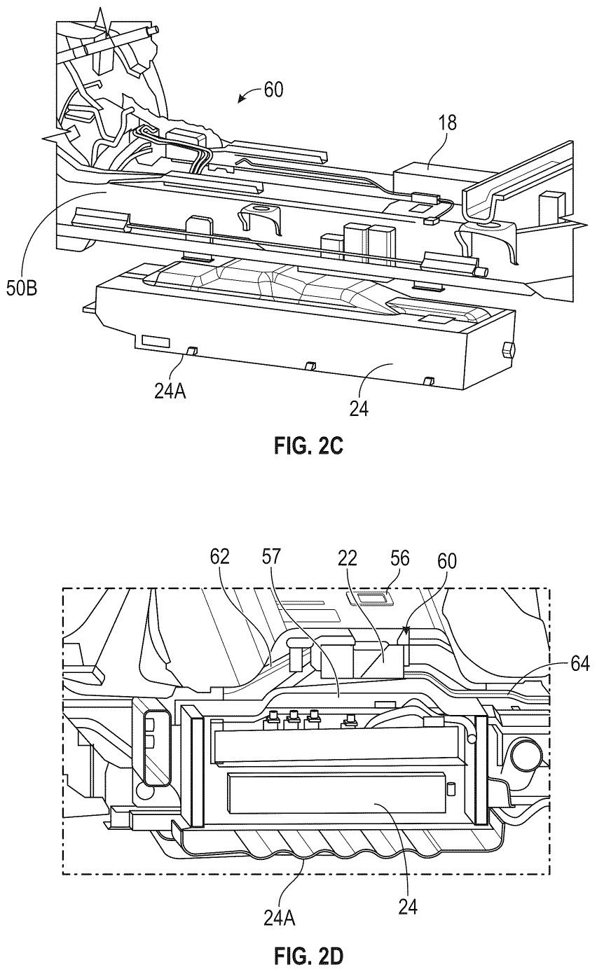

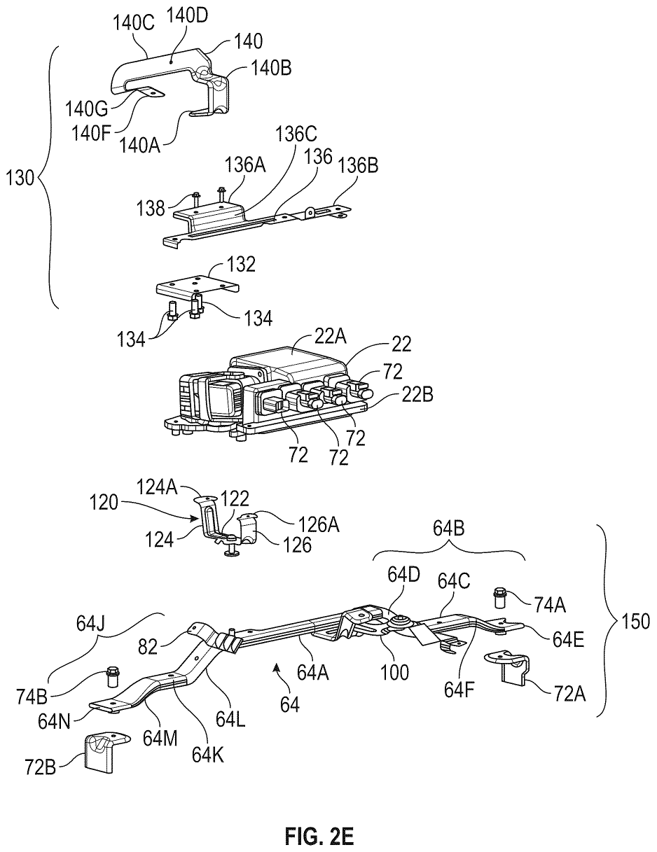

Referring now to FIG. 2A, a cutaway portion of vehicle 10 is illustrated. In the present example, the vehicle 10 has the battery 24 that is positioned between a first frame rail 50A and a second frame rail 50B. The frame rails 50A, 50B extend longitudinally relative to a longitudinal axis 52 of the vehicle. The perspective of FIG. 2A is from the middle of the vehicle toward the front of the vehicle. A removable tunnel cover 56 is disposed over the battery and other components, such as the generator 14 and the PDC 22, as described in greater detail below. A second cover 58 may allow accessibility to components such as fuses or other replaceable components there beneath.

Referring now to FIG. 2B, the tunnel cover 56 has been removed to reveal the area or volume beneath the tunnel cover 56 which is defined as the tunnel 57 (shown best in FIG. 2D). The tunnel 57 has electrical control components 60 and the connecting cables therein. The electrical control components 60 allow the battery 24 to be serviced by removing the battery 24 from between the frame rails 50A, 50B. When removing the battery 24, the electrical components 60 remain in place. That is, the electrical control components 60 are supported by the frame cross member 62 and a first rear support bracket 64.

Referring now also FIG. 2C, the electrical control components 60 remain supported by the frame rails 50A, 50B while the battery 24 is lowered from the frame rail 50A, 50B. It should be noted that the battery 24 has skid plates 24A fastened on the lower side thereof. The skid plates 24A protect the battery during operation. By this positioning, the battery 24 is disposed between the frame rails rather than beneath the frame rails. This is illustrated best in FIG. 2D, where a cross-sectional view of the battery 24, the electrical control components are disposed above the battery 24 but below the tunnel cover 56. All of the relative directions are set forth relative to the normal operating direction of the vehicle. In particular, the PDC 22 is disposed above the battery 24 within the tunnel and is supported by the frame cross-member 62 and the first rear support bracket 64 which is partially illustrated in this example.

Referring now specifically to FIG. 2B, the power distribution center 22 has a plurality of high voltage wires 70 having connectors 72 coupled thereto. In the present example, four high voltage wires and four connectors 72 are illustrated. However, in other examples, a greater number or lesser number of high voltage wires and connectors 72 may be provided. The power distribution center 22 has a housing 22A that has an extension 22B that is supported directly by the first rear support bracket 64. In this example, the extension 22B is generally rectangular in shape and elongated in the lateral direction relative to the vehicle. The extension 22B is thus above the first rear support bracket 64.

As shown best in FIG. 2E, the rear support bracket 64 has a middle portion 64A that extends generally laterally relative to the vehicle. The middle portion 64A is generally horizontal and positioned above the battery 24. The first end portion 64B has a horizontal portion 64C. The horizontal portion 64C is coupled to the middle portion 64A by an angular portion 64D. An end 64E of the first support bracket 64. The end 64E is generally horizontal and is coupled to the horizontal portion 64C by a second angle portion 64F. A rear support bottom bracket 72A couples the end 64E to the first frame rail 50A. A fastener 74A may be used. The first rear support bracket may be symmetrical and therefore a second portion 64J couples the middle portion 64A to the second frame rail 50B through the rear support bottom bracket 72B. The second end portion 64J has a horizontal portion 64K coupled to an angular portion 64L which, in turn, is coupled to the middle portion 64A. A second angular portion 64M couples the horizontal portion 64K to an end portion 64N. The fastener 74B couples through the end 64N which is generally horizontal to the rear support bottom bracket 72B.

Referring back to FIG. 2B, fuel lines 78 are coupled adjacent to the power distribution center 22. In this example, the power distribution center 22 has the fuel lines in front thereof to the left side thereof and from the left side slightly behind and over toward the second frame rail 50B. A plurality of quick disconnect 78A are used during the assembly process to allow easy connection of the fuel lines. A second set of quick disconnects 78B may be provided toward the front of the vehicle in front of the power distribution center to allow quick connection and disconnection during the assembly and surfacing processes for the vehicle.

A second fuel line support bracket 82 is coupled to the angular portion 64L. The fuel lines 78 are guided toward the second frame rail 50B by the second fuel support bracket 82. In this way, the fuel lines 78 are suspended above the battery 24 and within the tunnel defined by the area below the tunnel cover 56.

A high voltage support bracket 100 is coupled to the middle portion 64A of the rear support bracket 64. In this example, the second support bracket 100 is coupled below the rear support bracket and the middle portion 64A thereof. Details of the second support bracket are described in greater detail below.

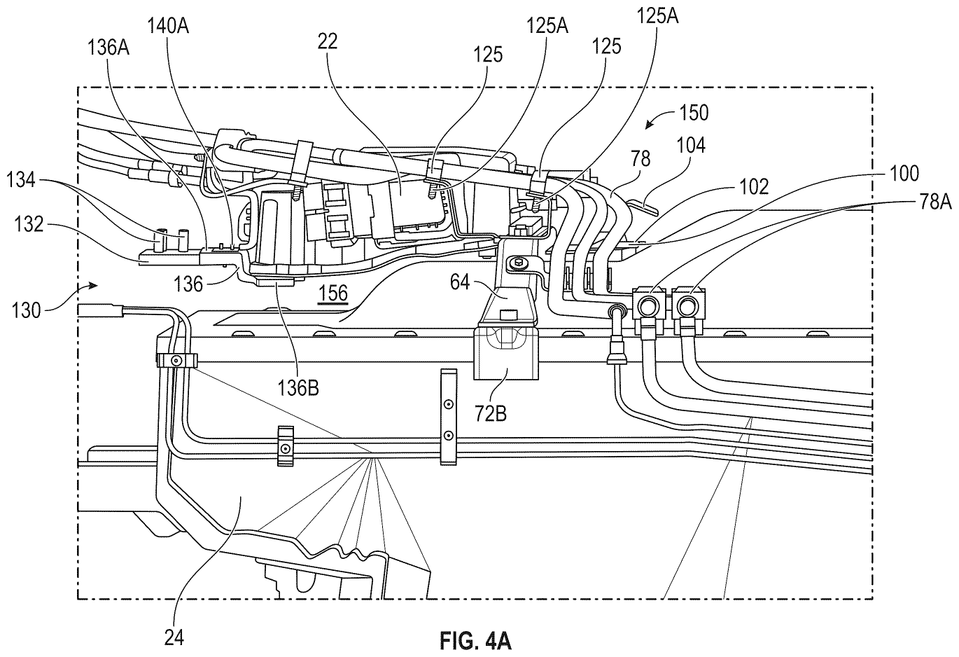

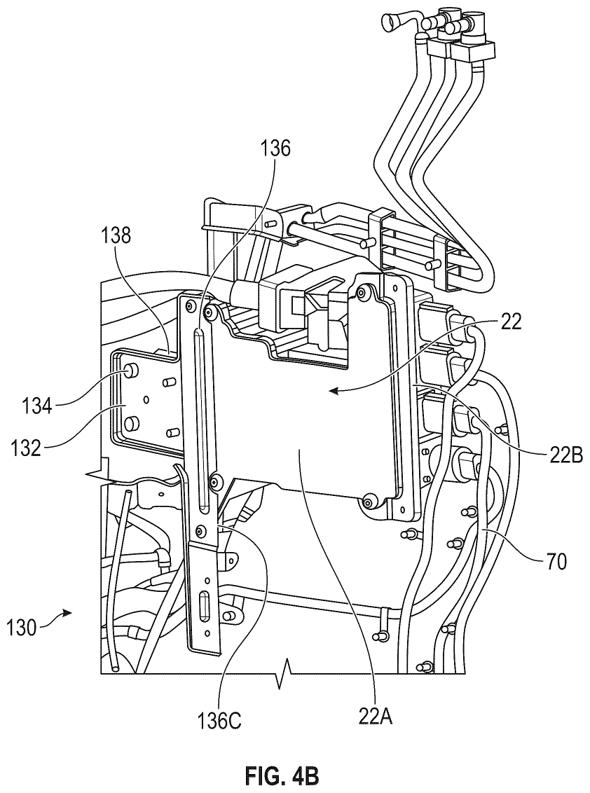

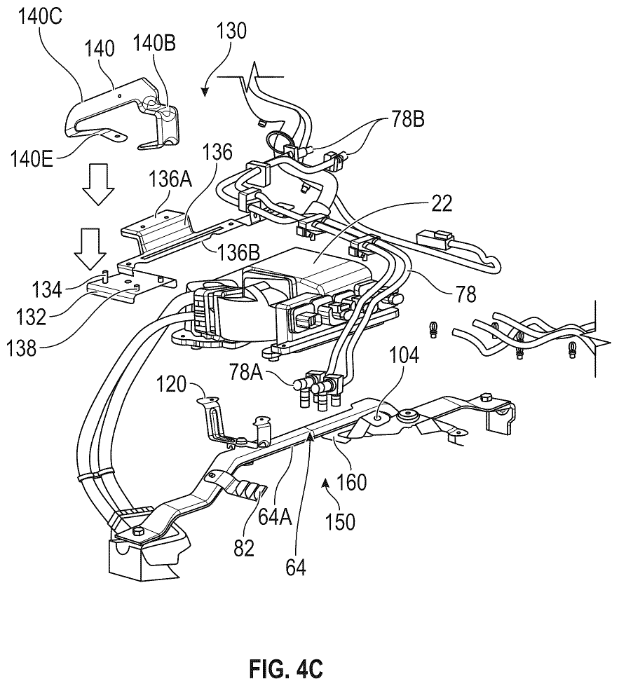

The middle portion 64A of the rear support bracket 64 has a fuel line support bracket 120 coupled thereto. The fuel line support bracket 120 has a central portion 122 that extends generally longitudinally relative to the vehicle. The central portion 122 has a first member 124 and a second member 126 extending generally vertically therefrom. However, the first member 124 and the second member 126 may only extend upward and therefore be at an angle relative to the central portion 122. A clip rest 124A is coupled to or formed with the first member 124. A second clip rest 126A is coupled to or form with the second member 126. The clip rests 124A, 126A are each used for supporting a clip 125 with fasteners 125A (shown in FIG. 4A) that clips to the fuel lines 78 as described in greater detail below. Between the first member 120 and the second member 126, the fuel lines 78 generally run longitudinal relative to the vehicle 10 and are at the left side of the power distribution module 22. In this manner, the fuel lines 78 remain above the support bracket 64, the fuel line support bracket 120 in the area adjacent to the power distribution center 22. In all cases, the fuel lines 78 remain above and separated from the battery 24. The fuel lines 78 are also separated from the tunnel cover 56 illustrated in FIG. 2A.

FIG. 2E also illustrates a front bracket assembly 130 that is used for supporting the front of the power distribution center 22. As will be described in greater detail below, a first front bracket 132 is generally planar and couples to the bottom of the frame cross member using the fasteners 134. In this example, three fasteners are illustrated. However, a greater or lesser number of fasteners 134 may be used.

A second front bracket 136 has a first planar portion 136A and a second planar portion 136B that are coupled together by a center portion 136C. The planar portion 136A and the planar portion 136B are on different planes that are separated by the distance of the third member 136C. The first planar portion 136A couples to the first front bracket 132 using fasteners 138. In this example, the first planar portion 136A is above the first front bracket 132. The second planar portion 136B is disposed below the housing 22A of the PDC 22 so that the second portion directly supports the PDC 22. In combination with the rear support bracket 64, the PDC 22 is adequately supported during operation of the vehicle and to allow servicing of the vehicle so that the battery may be removed in a downward direction from between the frame rails 50A and 50B.

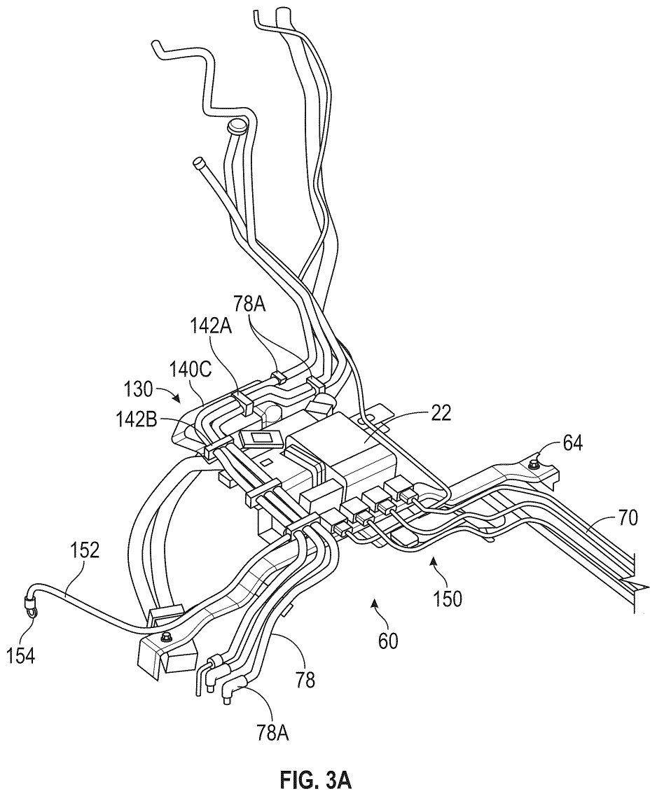

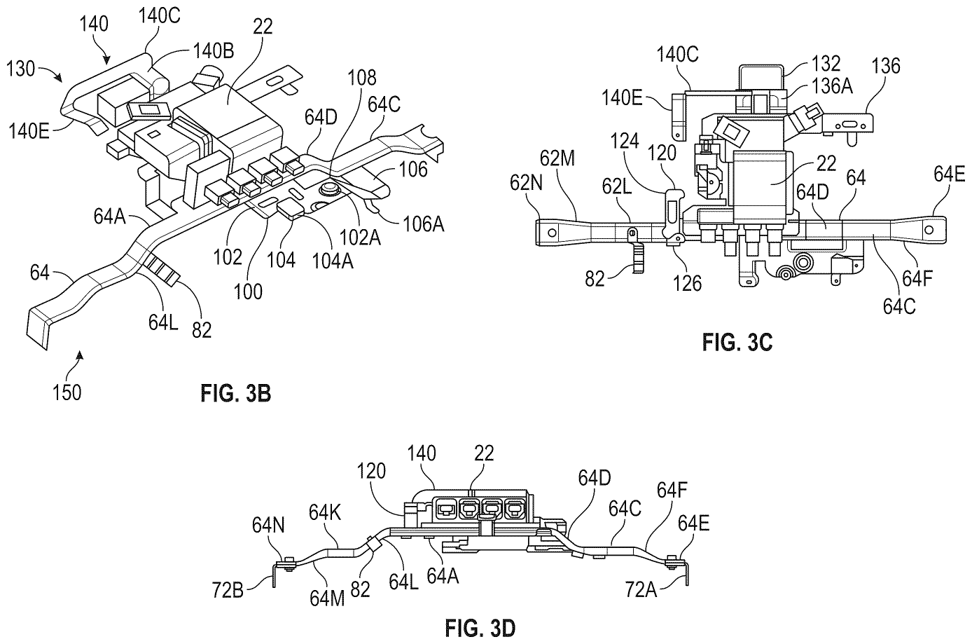

The fasteners 138 are also used to secure a third front bracket 140 to the first planar portion 136A of the second bracket 136. The front bracket 140 has a first planar portion 140A that is coupled against and parallel with the first portion 136A of the bracket 136. An arm 140B extends upward and rearward and provides a coupling to a guide portion 140C. The guide portion 140C extends in an upward direction relative to the vehicle. As will be described in greater detail below, the guide 140C may direct the fuel lines 78 and opening 140D may be used to receive a clip 142 (shown in FIG. 3A a). A second arm 140E extends generally in a rearward direction relative to the vehicle. The arm 140E has an opening 140F used to receive a clip 142B (shown in FIG. 3A) for securing the fuel line 78. It should be noted that in various vehicles, fuel lines may not be present such as in a fully battery electric vehicle.

Referring now to FIG. 3A, the PDC 22, together with the fuel lines 78, the high voltage wire 70 are illustrated together with the rear bracket assembly 160 and the front bracket assembly 130. It should be noted that a ground wire 152 has a contact 154 that is secured to the frame rail 50B with a fastener. The ground wire 152 grounds the PDC 22.

Referring now to FIG. 3B, a perspective view of the PDC 22, the front bracket assembly 130 and the rear bracket assembly 150 is illustrated. The difference between FIG. 3A and FIG. 3B is that the fuel lines 78 and the high voltage wires have been removed for clarity purposes. In this example, the second support bracket 100 is illustrated in further detail. In this example, the second support bracket 100 has a first portion 102 that is coupled to the underside of the first rear support bracket 64 at the middle portion 64A. An upright member 104 extends upward from the first portion 102 and has an opening 104A for receiving a clip to hold a high voltage wire thereby. An opening 102A in the first portion 102 may be used to hold a clip for securing another high voltage wire 70.

The second support bracket 100 has a second portion 106 disposed below the first portion 102. The second portion 106 may be planar and parallel to the first portion 102. The second portion 102 may include a clip holder 106A for securing a clip for holding a high voltage wire 70 thereto. An angular portion 108 extends between the first portion 102 and the second portion 106 of the second support bracket 100. The angular portion may be directly adjacent to the angular portion 64D of the rear support bracket. The second portion 106 of the second support bracket 100 may be directly adjacent to the horizontal portion 64C of the rear support bracket 64.

FIGS. 3B-3D show various illustrations of the interconnections of the various components of the front bracket assembly 130 and the rear bracket assembly 150.

Referring now to FIG. 4A, the battery 24 is illustrated with the front bracket assembly 130 and the rear bracket assembly 150. The PDC 22 and the housing 22A thereof is illustrated relative to the second front bracket 136 which, as shown, has the second planar portion 136B disposed underneath the PDC 22 so that a gap or space 156 is maintained between the top of the battery 24 and the bottom of the PDC 22. The frame cross member 62 to which the fasteners 134 are fastened has been removed for simplicity of the illustration.

Referring now to FIG. 4B, the underside of the PDC 22 is illustrated. In this example, the first front bracket 132 shows the heads of the fasteners extending upward while the fasteners extend downward into the first front bracket 132. The second front bracket 136 and, in particular the second planar portion 136C, are shown as supporting the underside of the PDC 22. The extension 22B of the PDC housing 22A is also illustrated in greater detail.

Referring now to FIG. 4C, an exploded view with arrows illustrating the order for assembling the system is set forth. The first front bracket 132 is secured with the bolts or fasteners 134 to the bottom of the frame cross member 62. The fasteners 138 are used to secure the second front bracket 136 to the first front bracket 132. The PDC 22 is thereby secured to the portion 136B of the second bracket 136. The third bracket 140 is secured to the first portion 136A of the second bracket 136. After assembly, the fuel lines 78 may be assembled. For the rear support bracket 64, the rear support bracket 64 is coupled to the frame rails 50A and 50B illustrated above. The second bracket 100 may be secured to the underside of the first rear bracket 64. The fuel line support brackets 82 and 120 may also be secured to the rear support bracket.

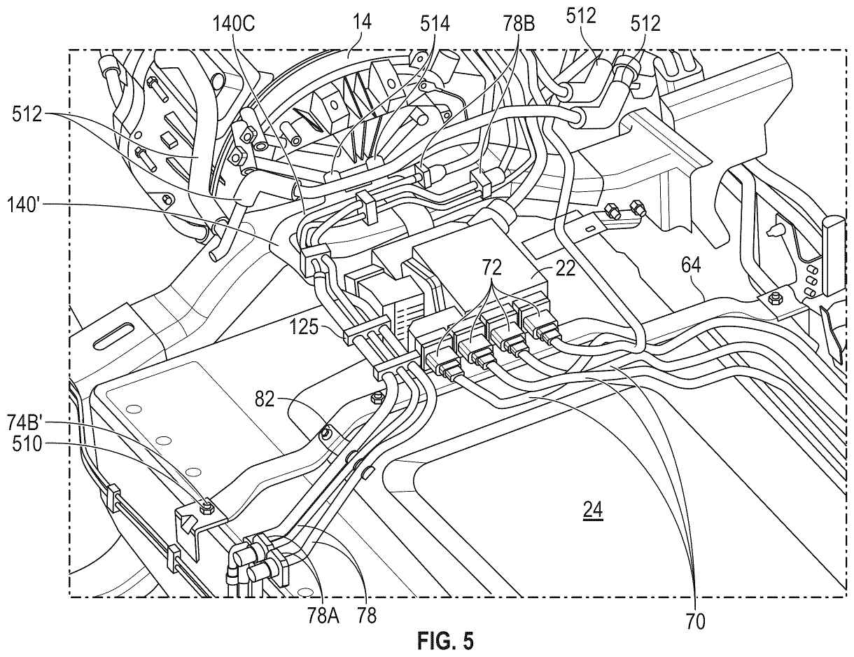

Referring now to FIG. 5, a similar view to FIG. 2B is set forth. In this example, bolt 74B′ extends upward relative to the vehicle 10. That is, the fastener 74B′ provides a nut 510 on the upper part of the bracket 64 rather than a head as illustrated above. Further, the third front bracket 140′ has a modified design. A plurality of cooling lines 512 is illustrated in this example. The cooling lines 512 are coupled to the modified third front bracket 140′. Extensions 514 extend in a generally vertical direction from the guide 140C. The extensions 514 extend laterally relative to the vehicle 10. In this example there are two extensions 514. However, one or more than two may be provided. The extensions 514 provide a mounting position for a cooling line 512. A strap, fastener or coupler may couple the cooling line 512 to the extensions 514.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. 1steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a first frame rail;
a second frame rail;
a frame cross member disposed between the first frame rail and the second frame rail;
a first support bracket coupled to the frame cross member and the second frame rail above a battery;
a second support bracket coupled to the first support bracket; and
a power distribution center coupled to the second support bracket.

2. The vehicle of claim 1 further comprising a third support bracket coupled to the second support bracket.

3. The vehicle of claim 1 wherein the frame cross member supports a generator.

4. The vehicle of claim 1 wherein the first support bracket is coupled below the frame cross member.

5. The vehicle of claim 1 wherein the first support bracket comprises a first end coupled below the frame cross member and a second end coupled to the second support bracket.

6. The vehicle of claim 1 wherein the second support bracket comprises a first planar portion coupled to the first support bracket.

7. The vehicle of claim 6 wherein the second support bracket comprises a second planar portion.

8. The vehicle of claim 8 wherein the second planar portion is disposed below the power distribution center.

9. The vehicle of claim 7 wherein the second planar portion is disposed on a different plane that the first planar portion.

10. The vehicle of claim 7 further comprising a third support bracket coupled to the second support bracket.

11. The vehicle of claim 10 wherein the third support bracket is coupled to the second planar portion of the second support bracket.

12. The vehicle of claim 11 wherein the third support bracket comprises a first planar portion coupled to the second planar portion of the second support bracket.

13. The vehicle of claim 12 wherein the third support bracket comprises a first arm extending from the first planar portion of the third support bracket.

14. The vehicle of claim 14 wherein the first arm extends upward and forward relative to the vehicle.

15. The vehicle of claim 14 wherein the first arm is coupled to a guide.

16. The vehicle of claim 15 wherein the guide extends laterally relative to the vehicle.

17. The vehicle of claim 16 wherein the guide supports a plurality of fuel lines.

18. The vehicle of claim 16 wherein the guide extends vertically.

19. The vehicle of claim 16 wherein the guide comprises a second arm extending rearwardly from the guide.

20. The vehicle of claim 19 wherein the second arm comprises a clip.
